(19) United States
(12) Patent Application Publication
(10) Pub. No.: US 2004/0001582 A1
(43) Pub. Date: Jan. 1, 2004

(54) Redirection of communication based on a party's presence

(76) Inventors: Anwar Siddiqui, Manhattanville, NY (US); Hal Zenner, Fair Haven, NY (US)

Correspondence Address: DEMONT & BREYER, LLC, SUITE 250, 100 COMMONS WAY, HOLMDEL, NJ, 07733, US

(21) Appl. No.: 10/185,030

(22) Filed: Jun. 28, 2002

(51) Int. Cl. H04M 1/64; H04M 3/42

(52) U.S. Cl. 379/211.01; 379/201.01; 379/88.17

(57) ABSTRACT

A telecommunications system is disclosed for a destination or “target” party to indicate his or her “presence” or availability to receive communications. The presence indication may include various states such as “available”, “unavailable”, “on vacation”, etc. Each time an initiating party attempts to navigate to a target party, the communications system informs the initiating party of a target party's presence status. The initiating party can then decide which menu path to choose: to continue to a covering party for the target party or the target party's coverage path, such as voicemail. In this manner, user frustration is alleviated, fewer telecommunications resources are consumed and both the initiating and target parties can communicate more effectively.

### FIELD OF THE INVENTION

This invention relates to the field of telecommunications and, more specifically, to a system and method for directing telecommunications to a party based on whether someone is present to receive the telecommunication.

### BACKGROUND OF THE INVENTION

Keeping “in touch” is very important today for most people. Many telecommunications are deemed to be urgent, so that the initiating party wants the target party to receive the communication as soon as possible. Many different systems are in place to help people stay “in touch,” such as cellular telephones, pagers, email, video, instant messaging and voicemail. Until these systems are fully integrated into one seamless telecommunications system, however, delivering telecommunications to a target party remains a hit-or-miss affair.

For example, most people have experienced the frustration of trying to navigate a telephone voicemail menu system only to end up at an undesired destination that is possibly the last place that the initiating party wants to leave a message (e.g., dialing “0” to leave one person's voicemail only to end up at the covering party's voicemail). There is no option available except to start over by reinitiating the telecommunication—and to navigate the same menu system again. Ironically, the purpose of these menu systems is to facilitate communications without the expense of human intervention. However, current menu systems actually cause frustrations, tie up telecommunications resources and frequently lead to an initiating party to abandon any attempt at communication.

For purposes of this specification, the following terms are used:

Telecommunications: voice and/or data communications by electronic transmission;

Initiating party: the person or persons that make a telephone call, send email, etc.;

Target party: the person for whom the communication is intended; and

Covering party: a person that may receive the communication in place of the target party (e.g., a secretary covering for a supervisor, etc.).

### SUMMARY OF THE INVENTION

This problem is solved and a technical advance is achieved in the art by a new facility whereby a party can indicate his or her “presence;” his or her availability to receive communications. Such presence indications may include various states, such as: available, temporarily unavailable, on vacation, etc. Each time an initiating party attempts to communicate with a target party and is instead presented with a menu of choices, the telecommunications system informs the initiating party whether or not each alternative party is present. The initiating party can then make an informed decision as to which menu item to select, such as continuing to the target party message storage or the target party's coverage path, such as a secretary. In this manner, customer frustration is alleviated because the initiating party can make a more informed choice. Thus, communication between an initiating party and a target party is enhanced.

### BRIEF DESCRIPTION OF THE DRAWINGS

A more complete understanding of this invention may be obtained from a consideration of this specification taken in conjunction with the drawings, in which:

FIG. 1 is a block diagram of an exemplary telephone network in which an exemplary embodiment of this invention can be implemented;

FIG. 2 is a flow chart of the operation of the exemplary embodiment of this invention; and

FIG. 3 is an exemplary embodiment of this invention in the context of a data communications system.

### DETAILED DESCRIPTION

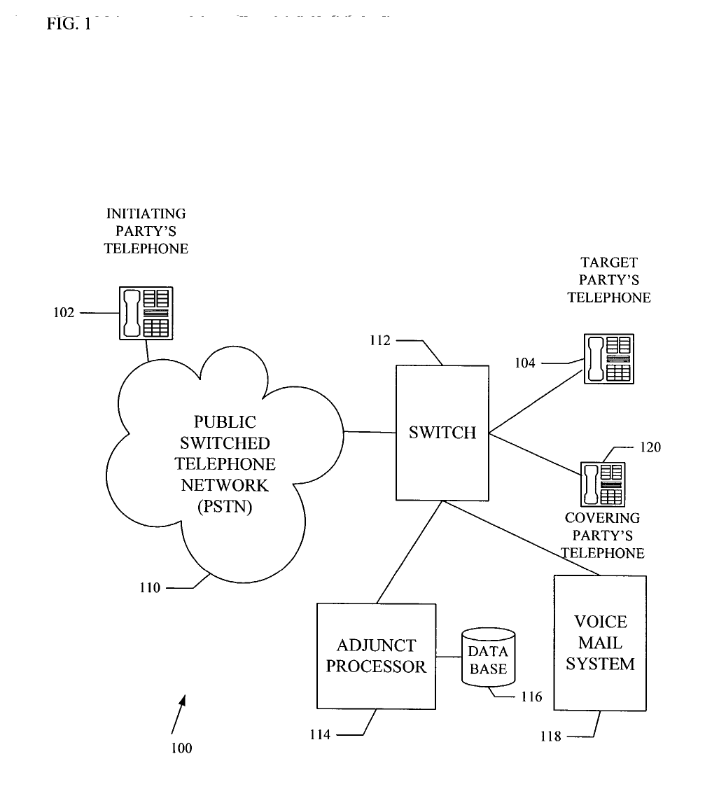

FIG. 1 is a block diagram of a telecommunications system illustrating an exemplary embodiment of this invention in the context of telephone network 100. For the purpose of describing a first exemplary embodiment of this invention, a simple call model is described, in order to illustrate the salient features of this invention. According to this exemplary embodiment, the user of telephone 102 (the “initiating party”) is attempting to call the user of telephone 104 (the “target party”). The initiating party at telephone 102 places a call to the target party by entering the telephone number of telephone 104. The public switched telephone network (PSTN) 110 processes the call in the normal fashion, the call is routed through PSTN 110 and delivered to a destination switching system, or “switch” 112. Switch 112 may be a Class 5 telephone switching system or may be a PBX, both of which are well known in the art.

Switch 112 is the home switch of telephone 104 (the switch that telephone 104 is physically connected to), and, therefore, supports the features associated with telephone 104, such as voicemail, telephone coverage, etc. Switch 112 may perform all of the processing for telephone 104 and its associated features itself, or may have one or more adjunct processors 114 to assist. Adjunct processor 114 may be directly connected to switch 112 or may be part of an intelligent network, as is known in the art, and, therefore, not further shown or discussed herein. Adjunct processor 114 includes database 116, which stores data associated with each telephone and their respective features, as is known in the art. Further, switch 112 is connected to voicemail system 118. Voicemail systems such as 118 are also well known in the art, and are, therefore, not further described.

As part of the feature set for telephone 104, switch 112 supports voicemail system 118 and answer coverage at telephone 120. Answer coverage at telephone 120 comprises a ringing signal delivered to telephone 120 when a ringing signal is delivered to telephone 104. Further, a call may be redirected to telephone 120 as part of a voicemail service if the initiating party is offered the option of “dialing 0”, as is known in the art. In some systems, the call may be redirected to telephone 120 without an option being presented to the initiating party.

Continuing with the above example, the call from telephone 102 to telephone 104 is presented to switch 112. When it receives the call, switch 112 determines the features associated with destination telephone 104. The switch then sends a ringing signal to telephone 104 (and optionally to telephone 120). If telephone 104 is not answered after a predetermined number of rings, then switch 112 determines what action to take.

In this example, switch 112 redirects the call to voicemail system 118. Voicemail system 118 queries the initiating party at telephone 102 to determine if he or she want to record a message for the target party or to reroute the call the covering party at telephone 120, which may be a secretary or other person designated to cover calls to telephone 104. The initiating party at telephone 102 then makes a selection of one of the two options. Alternatively, the initiating party may not be presented with an option and the call is automatically redirected to telephone 120.

According to the prior art, if the initiating party at telephone 102 selects the option to reroute the call (or the call is automatically redirected), the call is immediately presented to telephone 120 by switch 112 as if the call were originally directed to telephone 120. If telephone 120 is not answered after a predetermined number of rings, then switch 112 takes action dependant upon the feature set associated with telephone 120. In most cases in the prior art, the call is routed to the voicemail box of the covering party at telephone 120. If the initiating party would rather leave voicemail for the original target party instead, then he or she must hang up and start again.

According to the exemplary embodiment of this invention, if the target party does not answer telephone 104, then switch 112 or adjunct processor 114 makes a determination of whether or not the covering party at telephone 120 is present (i.e., available). The system then delivers this information to the initiating party at telephone 102, who may then make an informed choice as to how to direct the call. The menu presented to the initiating party at telephone 102 includes an option to deliver the call to voicemail for telephone 104 or to deliver the call to telephone 120, along with an indication of whether or not the covering party at telephone 120 is present. Thus, the initiating party at telephone 102 can make an informed decision as to how to direct the call. There may be further options presented, including, but not limited to, redirecting the call to a human operator, redirecting the call to a paging system or redirecting the call to a cellular telephone. There are many other scenarios possible that one skilled in the art will be able to apply this invention to after studying this specification.

Alternatively, the call may not be redirected if the covering party is not present. The switch 112 or adjunct processor 114 makes a determination of whether or not the covering party at telephone 120 is present, as in the above example. The system, however, does not deliver the current presence status of the covering party to the initiating party. Instead, the system performs the default action for the target party, such as redirecting to call to voice mail system 118.

In order to establish a party's “presence”, the party enters, in a first example, his/her usual voicemail service telephone number. The voicemail service then prompts the user for his/her presence status. The “presence status” may include more that just an in or out indication; it may include whether the user is out on business, on vacation, temporarily out of the office (e.g., out to lunch, etc.) or other status. Furthermore, there may be a menu or a button physically on telephone 120 to change the presence status.

Alternatively, a party may use a data entry device, such as a personal computer, to indicate or change his/her presence status. A local area network or other network, such as the Internet, delivers this information to voicemail system 118, database 116 or other system that stores the presence status, which stores the status until changed. Further, there may be a generalized web page or rule-based system that determines a person's presence (e.g., the party has not used his or her keyboard for one hour or time of day, day of week, etc.). A person's presence may also be based on a timecard-like system so that the presence status may be automatically obtained without a person having to change his or her presence status in multiple systems.

According to another exemplary embodiment, the initiating party at telephone 102 may be interacting with an automated system (e.g., a bank, credit card company, etc.) to obtain, for example, information regarding an account. The call is handled by adjunct processor 114, which runs a dialog script, as is known in the art. It is known in the art that a call to an automated system may reach a point where the initiating party is delivered to a target party (e.g., an agent, operator, etc.). It is also known in the art that the target party may not be present at the precise moment that adjunct processor 114 causes switch 112 to deliver the call to telephone 104.

In this exemplary embodiment of this invention, adjunct processor 114 first determines the current indication of presence of the target party by checking database 116. Adjunct processor 114 then processes the call according to presence of the target party. Such processing may include presenting an availability status to the initiating party and a menu of alternatives, or may include continuing the processing in the adjunct processor 114 or simply discontinuing the call.

There are many benefits to both the initiating party and the users (human or automated) of the invention. Further, precious bandwidth is not wasted in the telephone network, data network, etc. A transfer is not initiated (e.g., ring a party) if the party is not available. Additionally, initiating parties are not forced to wait through many ring cycles, reinitiate (and possibly re-reinitiate) calls, or both, in search of an appropriate destination. Thus, a system according to this invention provides an improved telecommunications environment while requiring only minor modifications to the existing telecommunications platforms. Further, an embodiment of this invention can be easily integrated with Session Initiation Protocol (SIP) to provide enhancements to SIP.

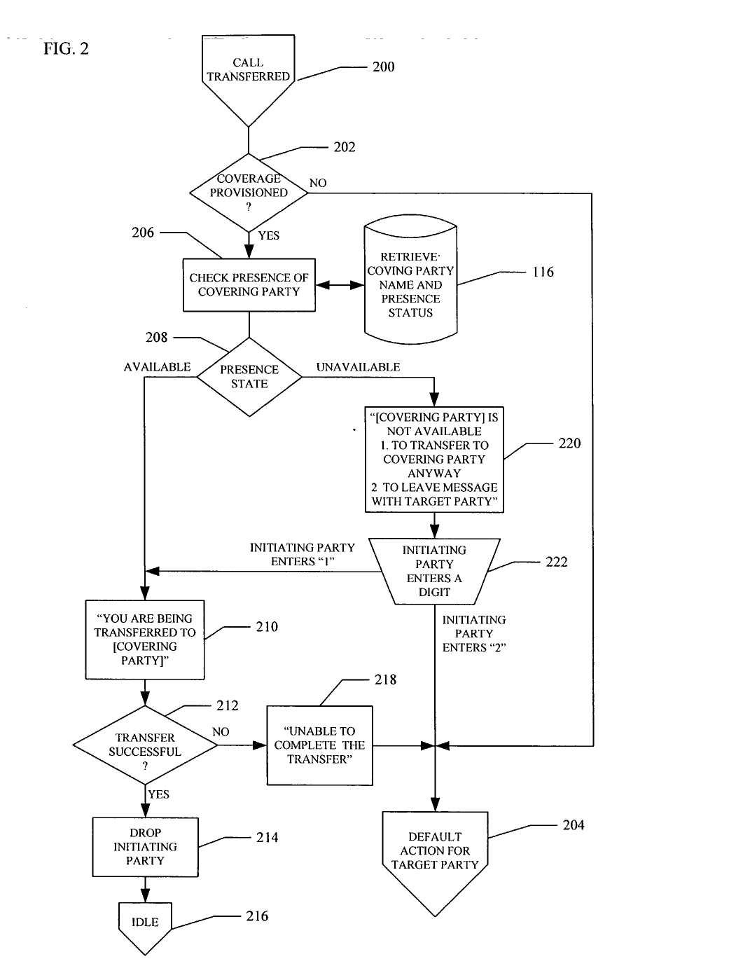

Turning now to FIG. 2, a flow chart of processing according to one aspect of this invention in adjunct processor 114, or voicemail system 118, or both, is illustrated. Processing begins in connector 200, when a call is transferred to this process according to one exemplary embodiment of this invention. A determination is made in decision diamond 202 whether coverage according to this invention is provisioned. If coverage is not provisioned, processing moves to connector 204, where the default action for the target party is taken (e.g., transfer to voicemail, etc.).

If, in decision diamond 202, coverage is provisioned, then processing proceeds to action box 206. In action box 206, the presence of the covering party is determined by retrieving the presence status and, advantageously, the name of the covering party from database 116 (FIG. 1). A determination is made in decision diamond 208 whether the covering party is available. If the covering party is available, then processing continues to action box 210, where an announcement is optionally played, stating that “you are being transferred to [covering party].”

Processing continues to decision diamond 212 where a determination is made whether the transfer is successful. If the transfer is successful, then the initiating party is dropped in action box 214, and the call state for the target party transitions to “idle” in connector 216. If, in decision diamond 212, the call transfer is not successful, then processing moves to action box 218, where, advantageously, an announcement is played stating that the system is “unable to complete the transfer,” and processing moves to the default action connector 204.

If, in decision diamond 208, the presence state indicated “unavailable,” then a menu of presence-based choices is presented to the initiating party in action box 220. In this simplistic example, the choices comprise: “dial ‘1’ to transfer to the covering party anyway”, and “dial ‘2’ to leave a message with the target party” (i.e., perform the target party's default action). One skilled in the art will appreciate that there may be any number of other actions, such as entering a password to reach the target party's cell or home phone, sending a text message to the target party's pager or cell phone, etc., after studying this specification. The initiating party enters a digit in 222. If the initiating party enters “1”, processing proceeds to action box 210 and continues as described above. If the initiating party enters “2”, then processing proceeds to the default action for the target party in connector 204.

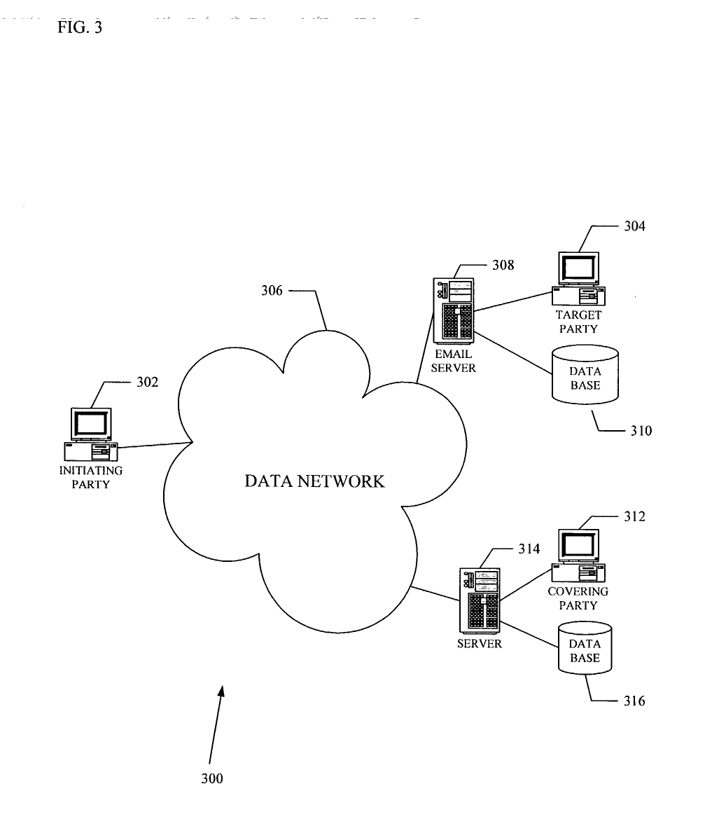

Turning now to FIG. 3, an all-data embodiment of this invention is shown generally at 300. According to an exemplary example of this embodiment of this invention, an initiating party at personal computer (PC) 302 is sending an urgent email to at target party PC 304. PC 302 transmits the email through data network 306. The email is received at a server 308 for an Internet service provider (ISP) that supports PC 304's email service. According to the prior art, the email is queued in database 310 for the next time the target party of PC 304 accesses email (either through PC 304 or remotely, as is known in the art).

As is known in the art, the target party can set email server 308 to send an “on vacation” notice to the initiating party at PC 302. Further, the target party may set email server 308 to forward all email to a covering party at PC 312. PC 312 may be connected to the same email server 308 as the target party, or, as illustrated herein, may be connected to another email server 314. The email is then queued for the covering party at database 316. This prior art system may be adequate for some applications; however, for urgent or private email there is a need for more careful handling of email.

According to this embodiment of this invention, before the message is queued at ISP 308, a message is sent to PC 302, which includes an indication of the presence of the target party at PC 304. Further, if the target party is not present, the message sent to PC 302 includes the fact that the original email message is going to be forwarded and includes the name (or email address, etc.) of the covering party. The message to PC 302 may also contain whether the covering party is present and a menu of choices as to how the original email message should be delivered. The initiating party at PC 302 may then make an informed decision as to how he or she wants to communicate the original email message.

There are many actions that could be initiated at this point. For example, if the original email message is time-dependent, then the initiating party may just cancel sending the email to prevent unnecessary and untimely responses from the target party, the covering party, or both. Further, the email may concern the covering party—such that the initiating party only wants the email queued for the target party. Additionally, if the message is important, email server 308 can forward the message to a voicemail system such as 118 (in FIG. 1) via data network 306. In this manner, the initiating party can control the delivery of his or her email in an informed manner.

It is to be understood that the above-described embodiment is merely illustrative of the present invention and that many variations of the above-described embodiment can be devised by one skilled in the art without departing from the scope of the invention. For example, this invention may be applied to video telecommunications and instant messaging by one skilled in the art after studying this specification. It is therefore intended that such variations be included within the scope of the following claims and their equivalents.

We claim:

1. A method for operating a communication system comprising:
answering a call for a target party after a predetermined time, wherein said call is made by an initiating party;
determining a presence of a covering party;
informing said initiating party of the presence of said covering party; and
presenting said initiating party options regarding delivery of said call based on the presence of said target party.

2. A method in accordance with claim 1 wherein said covering party sets a presence indication as a voicemail option.

3. A method in accordance with claim 1 wherein said covering party sets a presence indication as a menu option on a computer.

4. A method in accordance with claim 1 wherein said initiating party is informed of a presence of said target party.

5. A method in accordance with claim 4 wherein said initiating party is presented with the option of continuing to said covering party or continuing to said target party.

6. A method in accordance with claim 1 further comprising:
whenever said initiating party is presented with options for call handling, initiating party is informed of the presence of at least one of said target party and a covering party.

7. A communication menu system comprising:
means for receiving the initiation of a communication;
means for delivering an indication of the presence of a target party to the initiating party;
means for effecting by said initiating party a selection of how to connect a communications path for said communication.

8. A communication menu system in accordance with claim 7 wherein said communication menu system comprises a telephone answering system.

9. A communication menu system in accordance with claim 7 wherein said communication menu system comprises a voicemail system.

10. A communication menu system in accordance with claim 7 wherein said communication menu system comprises an email system.

11. A communication menu system in accordance with claim 7 further including means for delivering an indication of the presence of a covering party to said initiating party.

12. A communication menu system in accordance with claim 7 further comprising:
means for delivering an indication of the presence at least one of said target party and a covering party at each step in said communication menu system.

13. A method for operating a messaging system comprising:
receiving a message from an initiating party for a target party;
determining the presence of said target party;
informing said initiating party of the presence of said target party; and
presenting said initiating party options regarding delivery of said message based on the presence of said target party.

14. A method in accordance with claim 13 wherein said messaging system comprises an email system.

15. A method in accordance with claim 13 wherein said messaging system comprises an instant messaging system.

16. A method in accordance with claim 13 wherein said messaging system comprises a session initiation protocol system.
